(19) United States
(12) Patent Application Publication
(10) Pub. No.: US 2001/0034651 A1
(43) Pub. Date: Oct. 25, 2001

(54) Earning and using benefits for responses to internet advertising at a merchant location

(76) Inventors: Michael B. Marks, South Orleans, MA (US); Joel Marks, Sherman Oaks, CA (US)

Correspondence Address: Brad I Golstein, Metro88, 20755 Plummer Street, Chatsworth, CA, 91311, US

(21) Appl. No.: 09/789,845

(22) Filed: Feb. 22, 2001

Related U.S. Application Data
(60) Provisional application No. 60/185,196, filed on Feb. 25, 2000.

(51) Int. Cl. G06F 17/60

(52) U.S. Cl. 705/14

(57) ABSTRACT

An incentive benefit program compensates customers for viewing advertising and other activities while conducting business at a host merchant. The compensation is in the form of an immediate discount toward goods and/or services at the host merchant. The discount may be a reduction in the customer's bill, or additional product from the merchant. For example a customer may respond to ads on a display terminal of a gasoline pump while dispensing gas. The customer can then immediately receive additional gas or a reduced cost for the gas dispensed. A user releases no inherently valuable information, such as an email or home address or credit card number, to any entities to receive benefits. The user remains anonymous to the benefit provider and others. According to the invention a customer easily obtains benefits anonymously while the host merchant earns loyalty from such minimally identified customers.

### FIELD OF THE INVENTION

The present invention concerns incentives for responding to advertising and performing other activities that are presented by means of the Internet and other data networks.

### BACKGROUND

Typical incentive programs for viewing advertising on the Internet offer benefits that may be redeemed only at a later time. Such incentive programs are disconnected from advertising offers themselves so that a given incentive may appeal to a wide range of advertising viewers with regard to a broad spectrum of advertising. In U.S. Pat. No. 6,185,541 Scroggie et al. disclose an example of this method whereby the delivery of an incentive is disconnected from its redemption.

U.S. Pat. No. 5,687,322 and related patents by Deaton et al., disclose a method for providing incentives to customers at merchant locations in conjunction with the Internet. A key feature of Deaton is that the customer is known in connectioin with a database of previous transactions.

U.S. Pat. No. 6,061,660, Eggleston et al. disclose another method of implementing an incentive program in conjunction with the Internet and the possible participation of merchant locations.

The provision of advertising and incentives to consumers at the point of consumption may incorporate the use of one or more terminals within a merchant location. Examples of Internet advertising appearing on terminals at merchant locations are disclosed in U.S. Pat. No. 6,176,421 by Royal, Jr. et al (gas stations and restaurants) and U.S. Pat. No. 5,949,411 Doerr et al. (remote kiosks for movie and music promotions). Another form of merchant location is an airline passenger seat system wherein each passenger is provided with an individual entertainment unit; one version of such a unit is disclosed in U.S. Pat. No. 6,177,887 by Jerome. The presentation of advertising on such terminals may be in the form of a screen saver as disclosed in U.S. Pat. No. 6,084,583 by Gerszberg et al.

The prior art has envisioned the use of short-range and cellular network wireless devices for a variety of transactions including the purchase of goods and services and the delivery of coupons and other incentives. U.S. Pat. No. 6,175,922 by Wang discloses features typical to wireless transaction systems.

Consumers in both physical and Internet based merchant locations generally place a premium on disclosing personal information. The Internet makes it possible to track consumer activities by means of cookies. Cookies therefore present a potential threat to privacy and impose a transaction cost. To minimize this cost it is therefore desirable to limit the lifespan of a cookie identifier. U.S. Pat. No. 6,134,592 by Montulli discloses one method of creating a cookie with a limited life span.

Incentives such as frequent flier miles require the accumulation of benefit units to a given threshold before a benefit can be claimed. The units of value are stored in a consumer's account and may be accumulated in conjunction with various on-line and off-line activities. Rarely does a single activity produce enough benefit units to achieve a threshold. Thus a consumer must engage in multiple activities within connected incentive programs to achieve an award that can be claimed.

Coupons may offer awards that can be claimed in discrete units. However, when units are small, the transaction cost to a consumer of redeeming a coupon in a subsequent activity may exceed the value of the coupon itself.

Incentive programs that accumulate benefit units and incentive programs that utilize forms of coupons delay a consumer's gratification. Such delayed gratification may detract from the value a consumer assigns to a benefit. In order to deliver a benefit of given perceived value to a consumer, an incentive program provider must increase the value of the benefit to compensate for a consumer's delayed gratification.

If a benefit can be obtained from a program without a consumer being identified, or without the advertiser knowing information of likely monetary value about the consumer, the benefit will be more desirable and accorded higher value by the consumer. A benefit will be especially valuable if it is both anonymous and immediate. At the same time, an advertisement is most valuable to an advertiser and most beneficial to an audience when it can be targeted specifically to an audience with known characteristics.

### SUMMARY

An object of the present invention is to provide immediate or near term gratification for responding to Internet advertising. Another object of the invention is to minimize a consumer's exposure to an advertiser or incentive program provider. A further object of the invention is to provide an incentive program in a manner that encourages customers to conduct business and view advertising at locations where advertisements participating in the program are presented. Another object of the invention is to reduce the need to store or accumulate benefit credits at a third party location.

Purchasing goods and services, gathering information and enjoying entertainment (information and entertainment together comprising, “infotainment”) may occur or be experienced over an extended period of time; this time period provides an opportunity to present a customer or audience with advertising. An incentive program that promotes advertising responses will be enhanced if the benefit reduces the cost of a purchase or the cost of infotainment that is presently taking place or contemplated to take place shortly. It would be especially effective for activities where payment is made at or near the end of an activity. In this case the amount of a bill can be reduced before it is actually paid or a premium item may be delivered prior to the end of the activity.

A further advantage to immediate usability of a benefit is that less identification of a consumer is required. The activity is occurring at a physical location or in conjunction with a specific web site. While the consumer's whereabouts are known at that time, it is not necessary to know how to contact the consumer when he has gone somewhere else.

If a consumer is a customer at a known physical location and is paying by cash, he can be entirely anonymous, both in payment and in receipt of a benefit. If he is at a web site to make a purchase, he will not be anonymous to the web site since a credit card number or similar is required to make the purchase. But he will not need to provide any identification or contact information to an advertiser or incentive program provider that displays at the web site.

Advertising that has been targeted to audiences of known characteristics benefits both the advertiser and the audience. The present invention enables targeting by means of, 1) geographic location (perhaps by zip code, city, GPS coordinates), 2) product lines and services, 3) infotainment content, or 4) affiliation with a business franchise.

A business or web site that provides space or time for advertising is a “host location” or “host.” A consumer or customer is credited with a benefit if he acts upon an ad at the host location. In acting upon an ad the consumer performs an action to verify that he has seen (or heard), or had time to see (or hear), an ad. This is considered an ad “response” or “view.” In the preferred embodiment the consumer must make a purchase from the host location to actually receive the benefit. The host whom the consumer is currently visiting pays the benefit by way of a discount, premium or upgrade to the consumer. The incentive program provider and/or the advertiser or advertisement provider then reimburses the host. Alternatively, the host may act as the incentive program provider and supply benefits without reimbursement.

Under one embodiment of the present invention the benefits may be used immediately. In another embodiment, the benefits are accumulated, stored and controlled by the host on behalf of a consumer and may be used at a later time. In either embodiment, the consumer retains his anonymity with respect to the benefit provider except in the unique instance where the host acts as the benefit provider.

Hosts of the present invention include physical locations, Internet web sites where goods and services are sold and Internet web sites that distribute infotainment. Products provided by the hosts may include physical and intangible goods and services, and infotainment in a variety of forms.

In an alternative embodiment the host pays for the incentive program wholly or in part. This embodiment may include a means whereby an advertiser whose program benefits are paid by the host provides the host with an icon on the advertiser's ads; the host icon may be displayed on ads appearing away from the host's location.

If the incentive program is wholly operated by the host location, the advertiser may deal directly with the host and the host may pay the benefits directly to consumers in the incentive program.

In another embodiment the host may enhance the value of the incentive program by adding value to a benefit that is offered by an advertiser. For example, a host merchant may contribute a sum equal to that offered by an advertiser in the form of a “double discount.” In this example, a participating ad which offered a discount of $0.05 would actually deliver a discount of $0.10 to a customer who responded to the ad; the host merchant would deduct $0.10 from a customer's purchase; the advertiser directly or through the incentive program provider, would pay the host merchant $0.05.

In addition to advertisements from second and third parties, the advertisements participating in the incentive program of the present invention may also include advertisements provided by and for the host itself.

Advertisements displayed in conjunction with the present invention may include any information which an advertiser wishes to promote to an audience at a given location or set of locations.

Benefits may be earned, stored and accumulated by a host location on behalf of a consumer. This allows each host to utilize the present invention as a form of frequent visitor program.

### DESCRIPTION OF THE DRAWING

FIG. 1 is a schematic representation of a merchant-location based benefit program.

### DETAILED DESCRIPTION

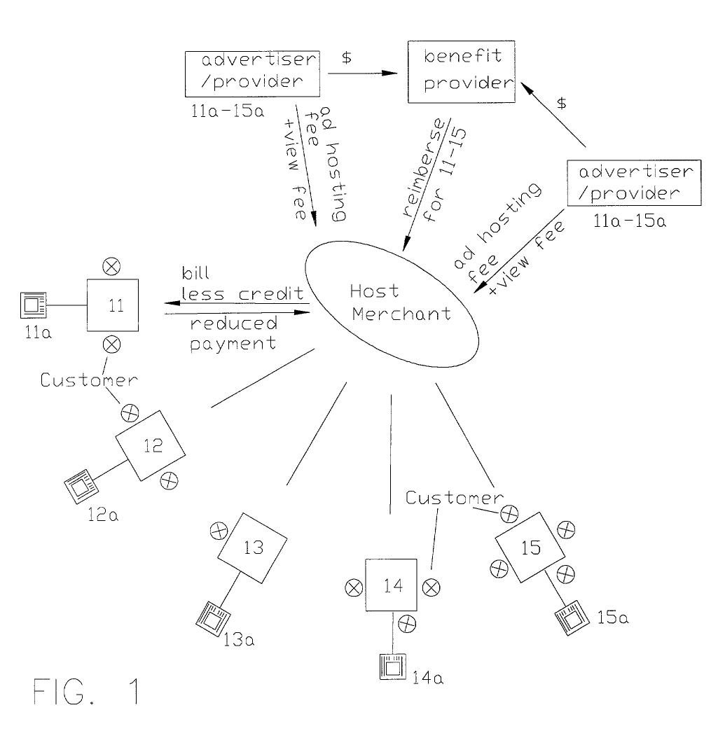

In FIG. 1 the host provides a product or service that customers are currently purchasing or considering purchasing (or infotainment with which an audience may be currently engaged or considering engagement). Positions 11 to 15 are customer terminals at the host location. The terminals are capable of showing Internet content along with on-line advertisements 11a-15a. Such terminals may incorporate, 1) a means for receiving customer responses and inputs, 2) a means for forwarding such responses and inputs to a host computer which may compile a record of the responses and inputs and 3) a means for correlating the responses and inputs to specific advertisements at the host computer so that it is known if a customer at a given terminal has responded to a given advertisement. When the present invention is used in conjunction with infotainment content the “customers” are audience members and the “terminals” may be any device capable of delivering infotainment content derived from the Internet to an audience member. When a customer or audience member responds to an ad participating in the incentive program of the present invention, he or she becomes a consumer.

Ads participating in the incentive program may be supplied by an advertiser, an advertising agency, a media buying agency or an advertisement consolidator, each of the foregoing comprising an example of an “advertisement provider” or “advertisement supplier”. The advertisement provider may also act as the incentive program provider. Participating ads may include a digital identifier that may signify participation in the program to the host computer and may further signify a specified level of benefit. The identifier could be comprised of an icon appearing on the ad.

If a consumer responds to an advertisement at a given terminal, the terminal may notify a computer at the host. Responding to an ad may mean clicking on a banner or page to see more detailed information from the advertiser. The host may know that an advertisement is participating in the benefit program by recognizing a digital identifier that is sent to the host when a consumer responds to an ad at the given terminal; alternatively the host may recognize that an ad is participating in the benefit program when it delivers the ad to the prospective consumer's terminal. Recognizing the digital identifier, the host may know the specified benefit (discount or premium) to be awarded to the given terminal. Further, the host may track the specific ads for which benefits are being paid such that the host may, 1) directly bill the incentive program provider or the advertisers whose ads have paid out benefits in conjunction with the program and 2) automatically receive payment for delivery of the benefit. The incentive program of the present invention is response based and may work in parallel with other advertising programs that may be billed on different bases such as page views or pay for responses.

When a consumer makes a payment to a host merchant for the merchant's product, the consumer may be recognized as the user of a given terminal on which a response to an ad within the incentive program has been recorded. Recognition of the consumer may be by automated means at the merchant's location (or web site), or by a worker who served or otherwise interacted with the consumer. The amount of the benefit specified by the incentive program provider (or the advertisement provider if acting as the incentive program provider) may be supplemented by an additional benefit supplied by the merchant. The total benefit that has been credited to the given terminal is then deducted from the consumer's bill or a premium item of given value may be delivered to the consumer. For simplicity this is shown for consumers at terminal 11 only.

When an ad is delivered to a given terminal or when a consumer at a given terminal responds to an ad, a digital identifier for the specific ad is recorded at the host terminal. When benefits are delivered in conjunction with a given ad, a record correlating the delivery of the benefit to the ad may be made at one or more of the following locations: the host computer, the incentive provider computer or the advertisement provider computer. The record may then be used to effect billing of the incentive provider by the host for the benefit that has been provided. The incentive provider may subsequently charge the advertisement provider for the benefit that was paid. Concurrently the record may also effect billing of the advertisement provider by the host for delivery of the ad itself.

One host may act in partnership with another host whereby, one or more secondary hosts subcontract space or facilities from a primary host. In this embodiment the possible and actual responsibilities of a host utilizing the incentive program of the present invention may be shared or subcontracted.

The incentive program provider does not need to accumulate or store credits for the host or consumer. The incentive program provider does not need to administrate the awarding of benefits. This simplifies administration of the program since no user identification number or tracking procedure is required. On an immediate or periodic basis the host may request reimbursement from the incentive program provider. The incentive program provider may have previously given the host a credit card number to effect automatic payment to the host when a benefit is paid in conjunction with a response to an ad participating in the incentive program. Concurrently or periodically the incentive program provider may invoice the advertisement provider for benefits that have been delivered in conjunction with delivery or response to a qualifying ad.

The benefit provider need not know any information about recipients of the credits. As seen in FIG. 1 the credit and payment transaction for responding to ads is handled between only the host merchant and his customer. Therefore the customer need not reveal himself to any entities, beyond the merchant with whom he is doing business, to gain use of the benefit program of the present invention. Use of the program may be spontaneous with no recording or registration process needed of any kind. The customer is identified only as an anonymous person who happens to be at a known location at a point in time. Even if the payment to the merchant is by credit card there need not be any record of the benefit transaction other than possibly a non specific “credit” entry on the user's receipt.

In FIG. 1 advertisements 11a-15a may all be the same or may be different; advertisements 11a-15a may also comprise multiple advertisements for different goods and services appearing at the same time on the same page (or screen); advertisements 11a-15a may also be audio or video advertisements. They need not be for or by the host merchant. Multiple credits may be accumulated during one visit to a merchant, up to a possible limit. Methods of verifying and valuing ad viewing activities are described in U.S. patent application Ser. No. 09/774559, “Providing Benefits by the Internet to Minimally Identified Users” filed Feb. 1, 2001. This patent application is incorporated herein in its entirety by this reference. These same methods may be used here, except that it is not required to associate with or identify any other existing benefit program. In this reference, an ad has a portion of its space dedicated to an icon symbolizing participation in the benefit program. When the present invention is used with audio content the icon may comprise an audible tone or series of tones. For the present invention a merchant or advertiser may request that some or all ads provide a benefit regardless of how they are viewed; no icons may be displayed since all ads appearing at a given host's location may be part of the incentive program. A merchant may tell his customers that viewing an ad at his place of business will provide a discount if a purchase is made.

A host location may display multiple ads simultaneously or sequentially. In this instance icons may be used to differentiate ads participating in the incentive program from ads not participating in the program. Further, differing icons or enhancements of a given icon may be used to signify differing incentive values. In this manner one ad may provide a discount of $0.XX while another may provide a discount of $0.YY and a third may provide another form of premium in ads that appear simultaneously (or sequentially) at a given host location.

The advertisements displayed on a terminal need not be related in content to content, products or services provided by the host. The only required relationship is location. The ads are delivered at the premises of a physical business, at an Internet web site or to a personal content device used in the proximity of a physical location or in conjunction with the Internet. A host merchant may not be directly paid as part of the benefit program, but may earn increased fees as more ads are viewed or may benefit from increased traffic resultant from customers seeking to participate in the incentive program. As described above, the host merchant may therefore offer to pay some or all of the incentive cost. In any case, the benefit provider may pay the fees to the host merchant on behalf of the advertiser or advertisement provider, whereby the benefit provider may bill the advertiser or advertisement provider later.

The incentive program provider, the benefit provider and the advertisement provider of the present invention may be joined in varying manners to comprise a single entity, multiple entities or parts of other entities. Joined together as a single entity, or cooperating as different entities, the incentive program provider, benefit provider and advertisement provider may be combined to offer an advertiser a single source to engage the incentive program of the present invention.

Many physical merchants could serve as hosts for the benefit program of the present invention. A merchant's customer must be associated with a terminal by which ads are viewed. If the purchase activity occurs at a specific location within a merchant's facility and requires enough time to enable ad viewing and responses, a terminal at the specific location may deliver the benefit in the form of credits. Examples of suitable merchants for this type of benefit crediting include a gas station and a restaurant.

In a gas station a dispensing pump includes the terminal for displaying and viewing ads. In FIG. 1 there are pumps 11 to 15. FIG. 13 is most accurate for this application in that there normally can be only one user per pump station at a given time. The terminal from which a credit was earned may be identified using standard billing and crediting procedures typical of gas stations. If the customer has responded to participating ads at the pump terminal he may be paid by an increased amount of change, a reduction in the charge to a credit card or ATM card, an increased quantity of gas beyond the amount paid or other form of premium such as a travel mug. The increased change or gas amount would be especially for cash payments. An increased quantity of gas is in a category of premium rather than discount.

In a restaurant there are tables 11 to 15 in FIG. 1, each with one or more guests. Internet ads 11a-15a are displayed at a terminal at each table. The terminal is linked to a host computer that in turn is linked to a computer that tabulates the restaurant's guest checks (one physical computer may comprise multiple independent computers). These links may be direct or by way of the Internet. When a guest at a terminal responds to a given ad the response is recorded at the host computer (or at the incentive program provider's computer) and correlated to the given ad. The benefit provided by the given ad or multiple ads may be a discount on the check amount or a free menu item. When the final check is tabulated for payment, the benefit may be calculated as part of the check to include the discount for any participating ads that received responses. Alternatively, a benefit, perhaps in the form of a free drink, may be delivered prior to the tabulation of the final check. The host computer may then invoice the incentive provider's account (and possibly the advertisement provider's account) for delivery of the benefit (and the ad). In a restaurant using computerized guest checks the crediting process could be at least partly automatic. Other examples of suitable merchants for the incentive program of the invention are a bowling alley or a supermarket cashier station. Any physical business where a customer is associated with an identifiable part of a merchant's facility for an extended period may effectively use the incentive program of the invention.

A further example is in an airliner on which a passenger's personal video screen acts as a customer terminal to show ad banners. A passenger's viewing terminal or screen location may be known in conjunction with a specified seat location on an aircraft. Viewing participating ads may enable discounts or upgrades on drinks, headphones, or free premium items, such as better peanuts. The passenger may receive benefits without providing (actively or passively) personal profile information to a database where it may be stored and correlated to other information. The viewing screen at the passenger's location may be linked to the Internet or to an onboard computer as part of an intranet whereby catalog items may be offered for sale; in this instance, the present invention may be used to provide discounts on catalog items if a passenger chooses to make a purchase. When a passenger responds to a participating ad a host computer on the airliner registers the response and signals that a benefit is due to be delivered to the passenger sitting in the seat correlated to the terminal on which the ad response was given. Depending on the nature of the benefit a premium item may be physically delivered to the passenger, a discount may be effected on a current transaction, or frequent flier miles may be entered into the passenger's frequent flier account.

If a user is not precisely locatable on a merchant's premises he may still receive a discount for viewing ads at the merchant's facility. In this case a coupon may be dispensed. For example in a supermarket checkout line, as opposed to the cashier station at the end of that line, a terminal could display information including participating ads. The terminal could dispense a paper coupon, or a temporary message in a user's portable wireless device.

The host computer, the advertisement provider's computer and the incentive provider's computer (and the benefits provider computer if the benefits provider is a different entity from the incentive program provider) may be at locations remote from the merchant and linked to the merchant by means of the Internet. The host computer, the advertisement provider's computer and the incentive provider's computer (and the benefits provider computer if the benefits provider is a different entity from the incentive program provider) may also be the same computer.

With respect to wireless devices, a host merchant may be associated and credited with specific ads by use of short range remote messaging. One such technology is a radio technology such as Bluetooth. Infrared is another short-range method. Using these or similar methods a merchant may provide localized information to users of wireless devices within an exemplary radius of approximately 100′ or less from at least one transmitter location, wherein the wireless signal is within or near by the merchant's business facility. Alternatively a user may receive information by means of a cellular network when the location of the user's wireless device is known. Ads viewed on the device when it is within or next to a given merchant could be credited to that given merchant. This would apply when the ads are transmitted by a short-range method from the merchant's facility or by the cellular network so long as the ad response is associated with a discount being given at the host merchant's location. A discount message for specific items or from the total bill could be sent to the wireless device, wherein the message may be encoded to be valid for a specific time period or for as long as the user's wireless device remains within a given proximity to the participating merchant. The given proximity may be defined by the typical, ideal or real broadcast radius of given wireless transmitter which communicates with wireless devices. The given proximity may also be defined using other parameters without reference to wireless technology.

A product ad could be presented to a user's wireless device when he is in a merchant's business. If the ad is viewed, a discount coupon message for the product advertised could be sent to the wireless device. At another extreme the merchant could make available ads from other businesses, possibly along with other information, when a wireless device is used at the business location. Viewing these ads while at that business location could allow credits to be awarded for use either at the business where the ads have received responses or at the business that has advertised. The host computer may utilize the Internet to coordinate the delivery of the benefit to the location most proximate to (or chosen by) the customer.

Wireless devices used in conjunction with the present invention may comprise the user terminal and receive, store and display information about the benefit as a bar code on a viewing screen or a print out that could be scanned by a participating merchant to effect enjoyment of the benefit at a time discontinuous from the delivery of the benefit information. In this embodiment the bar code may comprise the digital identification that tracks the advertising and activates the payment mechanisms. In effect, the bar code may act as a digital coupon.

Examples of possible wireless applications are in the aisles of a supermarket, or in a line waiting for a movie. The ad response benefits could comprise a discount on food items at the market, the ticket price at the movie or a premium such as a free popcorn at the movie.

The benefit program of the present invention may be also used for Internet merchants. If a customer logs on to a merchant's web site, he will be identifiable to the merchant. If the customer is an unknown visitor he could have an identifier or cookie sent to his web browser when he visits the merchant. The customer may ultimately be identified to the merchant if he makes a purchase. However, using the present invention, the benefit provider and advertiser do not need to know anything about the customer. Any participating ads that are viewed while at the merchant's site may be credited toward purchases from the host merchant. The credits may be stored in a customer's account at the web site or, alternatively may be stored in a cookie placed in the customer's browser by the merchant. If a potential customer leaves the merchant's site without buying anything to which credits may be applied, the credits may expire after a set time. Alternatively, the credits may accumulate at that merchant. However to achieve minimal identification of a customer, the credits and the cookie identity may expire when a user has left the site or shortly thereafter. A further benefit of short-term expiry is to encourage the user to stay or to quickly return to the host merchant's site and actually make a discounted purchase. As discussed above the ads that are viewed to earn credits at the host merchant need not be related to the host's business.

The present invention may be used in conjunction with infotainment providers such as news and entertainment web sites. In this embodiment information or entertainment content is delivered to a user's device by means of the Internet. The information and content may be accompanied by ads participating in the incentive program of the present invention. A user responding to ads within the program may receive a benefit that can be directly applied to services and products provided by the web site. This benefit may comprise a discount on fees for content or for services provided by the operator of the web site. A requirement of the benefit may be that it is used specifically during the time of a given visit to the given web site. However, as described above, the customer may accumulate benefits with the web site if the web site chooses to store the benefits on behalf of the user. If the benefit were accumulated it is stored by the web site and not by the benefit provider. Thus the customer is not revealed to the benefit provider.

An example of the present invention used in conjunction with an information provider is an on-line newspaper. A visitor to the newspaper's web site and may choose to respond to advertising displayed by or with the newspaper. Advertisements participating in the incentive program of the present invention may pay a benefit that can be directly applied to services and products provided by the newspaper. This benefit may comprise a discount on the subscription, free or reduced rate classified advertising, or services such as a free archival search. A requirement of the benefit may be that it is used during the time of that specific visit to the newspaper's web site. However, as described above, the customer may accumulate benefits with the newspaper if the newspaper chooses to store the benefits on behalf of the customer. If the benefit were accumulated it is stored by the newspaper and not by the benefit provider.

In the case of an on-line merchant the identification of the customer for giving the credit should be designed so that the benefit provider remains blind to the customer's identity. This is in accordance with a feature of the present invention wherein the user incurs no cost of being further identified when using the benefit program. A possible design is for the computer supporting the host merchant's web site to be able to identify ads on the site that are participating in the benefit program. The presence of an identifier in the form of an active response area signified by an icon as described above is one way to know an ad is in the program. A response to an ad in conjunction with the icon tells the merchant's computer to credit the customer's account if a purchase is made. The customer's account is known to the host web site by means of a cookie that has been previously installed in the customer's browser or by means of a log-in process whereby the customer has identified himself. The host merchant may then request reimbursement from the benefit provider; the reimbursement request may include identification of the ad that caused the crediting; this information may be used so that the benefit provider may accurately bill the advertiser. If an ad receives a response without a relationship to the icon or the benefit program, the crediting and debiting may be done in a different way, wherein the advertisement provider debits the advertiser and credits the merchant.

Advertising, content and benefits provided in conjunction with the present invention may be in one or more of the following forms: text, graphics, video and audio. Responses to advertising may be recorded by voice recognition, eyeball location tracking or other technology.

In any of the examples, a discount includes the concept of a free premium item given by the host merchant. In the present invention the term “merchant’ may be used to mean any entity that provides products, services or portions of content that may be purchased.

1. An incentive benefit program to encourage selected activities by users of a data network where a user is provided an opportunity to engage in the selected activity, and a benefit provider presents to the user an offer of compensation in return for the user electing to engage in the selected activity, wherein:
the user is a customer performing a current transaction at a host merchant, and the selected activity is available to the customer at a terminal at a facility of the host merchant during the current transaction;
the compensation includes a discount that is applied to at least one of products and services that are normally sold by the host merchant to customers conducting business at the host merchant;
the discount being offered to the customer during the current transaction, after the customer engages in the selected activity.

2. The benefit program of claim 1 wherein a customer accumulates compensation at the host merchant, and a record of a value for the accumulated compensation is maintained by the host merchant.

3. The benefit program of claim 1 wherein the selected activity comprises responding to advertising provided by the terminal at the host merchant.

4. The benefit program of claim 3 wherein at least one of advertisers and the benefit provider send payments to the host merchant as customers earn compensation at, and receive discounts from, the host merchant.

5. The benefit program of claim 4 wherein at least two of the advertisers, the benefit provider, and the host merchant are the same entity.

6. The benefit program of claim 1 wherein the host merchant comprises a gasoline station, the current transaction is purchasing gasoline, and the compensation is at least one of: a reduced price for gasoline purchased, and additional gasoline dispensed.

7. The benefit program of claim 6 wherein the customer's terminal comprises a display upon a dispensing pump.

8. The benefit program of claim 1 wherein the data network comprises the Internet.

9. The benefit program of claim 8 wherein the host merchant operates by means of a web site and the selected activity includes responding to at least one of: advertisements displayed on pages of the web site, and emails sent to the customer on behalf of the host merchant.

10. The benefit program of claim 1 wherein the customer operates a wireless device at the host merchant, and the wireless device comprises the terminal upon which selected activities may be performed.

11. The benefit program of claim 10 wherein the host merchant is a supermarket, the current transaction is shopping for goods, and the compensation includes a coupon usable for discounts on purchases at the supermarket.

12. The benefit program of claim 1 wherein the current transaction includes receiving transportation services from an airline, and the terminal comprises an entertainment device at a customer's seat.

13. The benefit program of claim 1 wherein the compensation is limited to use during the current transaction.

14. The benefit program of claim 2 wherein compensation may be accumulated during the current transaction, and the compensation may be used by the customer during a future visit to the host merchant.

15. The benefit program of claim 1 wherein the customer's identity to the host merchant is limited to a location of the terminal at the host merchant.

16. An incentive benefit program to encourage selected activities by visitors to a web site where a user is provided an opportunity to engage in the selected activity, and a benefit provider presents to the user an offer of compensation in return for the user electing to engage in the selected activity, wherein:
the visitor is a customer performing a current transaction at the web site, and the selected activity is available to the customer on a device that incorporates an Internet browser;
the compensation includes a discount that is applied to at least one of products and services that are normally sold by the web site to customers conducting business at the web site;
the customer engaging in the selected activity causing a cookie to be received by his browser;
the cookie causing a discount or other benefit to be provided by the web site to the customer upon the customer's transaction of business at the web site;
the cookie incorporating a mechanism that, upon the customer leaving the web site, causes the cookie to expire.
